(19) United States
(12) Patent Application Publication
(10) Pub. No.: US 2019/0277159 A1
(43) Pub. Date: Sep. 12, 2019

(54) TURBOCHARGER ASSEMBLY

(71) Applicant: GM GLOBAL TECHNOLOGY OPERATIONS LLC, Detroit, MI (US)

(72) Inventors: Yuli Huang, Auburn Hills, MI (US); Fanghui Shi, Bloomfield Hills, MI (US); Yuchuan Liu, TROY, MI (US); Bo Yang, Troy, MI (US); Louis P. Begin, Rochester, MI (US)

(21) Appl. No.: 15/916,331

(22) Filed: Mar. 9, 2018

(51) Int. Cl. F01D 25/16; F16C 17/02; F02C 6/12

(52) U.S. Cl. CPC F01D 25/164; F16C 17/028; F05D 2220/40; F02C 6/12; F16C 2360/24; F01D 25/166

(57) ABSTRACT

A turbocharger assembly includes a center housing which defines a bore, a journal bearing, and a rotating assembly. The bore further defines primary and secondary annular grooves. The journal bearing may be disposed within the bore such that the annular groove encircles the journal bearing and feeds the fluid thereto. The rotating assembly includes a shaft, a turbine wheel and a compressor wheel. The turbine wheel is configured to be driven by the post-combustion gasses while the compressor wheel pressurizes the airflow for delivery to a combustion chamber. The shaft may be supported by one or more journal bearings for rotation within the bore about a longitudinal axis. The shaft includes a shaft surface which defines a standard region and a feature in a feature region. The feature is configured to generate a plurality of fictitious forces which stabilizes the turbocharger shaft.

### TECHNICAL FIELD

The present disclosure relates to a turbocharged internal combustion engine and more particularly, to an improved rotary assembly for the turbocharger.

### BACKGROUND

Internal combustion engines are used to generate considerable levels of power for prolonged periods of time on a dependable basis. Many such engine assemblies employ a supercharging device, such as an exhaust gas turbine driven turbocharger, to compress the airflow before it enters the intake manifold of the engine in order to increase power and efficiency.

Specifically, a turbocharger utilizes a centrifugal gas compressor that forces more air, and thus, more oxygen into the combustion chambers of the engine than is otherwise achievable with ambient atmospheric pressure. The additional mass of oxygen-containing air that is forced into the engine improves the engine's volumetric efficiency, allowing it to burn more fuel in a given cycle, and thereby produce more power.

A typical turbocharger employs a central shaft which is supported by one or more journal bearings and transmits rotational motion between an exhaust-driven turbine wheel and an air compressor wheel. Both the turbine and compressor wheels are fixed to the shaft, which in combination with various journal bearing components constitute the turbocharger's rotating assembly. It is important to maintain the lubrication of the shaft at the interface between the shaft and the journal bearings which support the shaft by keeping an oil film between the shaft and journal bearing. However, due to the rotational speed of the shaft and the buildup of oil on one side of the shaft, unbalanced pressure may occur on one side of the shaft which may then cause the shaft to vibrate and cause noise. Thus, oil whirl is a self-excited instability with a subsynchronous frequency which commonly occurs in turbochargers when oil whirls in the journal bearing clearance. This undesirable condition may generate durability issues as well as unwanted noise. Accordingly, there is a need to reduce “oil whirl” in the turbocharger.

### SUMMARY

The present disclosure provides turbocharger assembly having a housing which defines a bore, a journal bearing, and a rotating assembly. The journal bearing may be disposed within the bore such that the annular groove encircles the journal bearing and feeds the fluid thereto. The rotating assembly includes a shaft, a turbine wheel and a compressor wheel. The turbine wheel is configured to be driven by the post-combustion gasses while the compressor wheel pressurizes the airflow for delivery to a combustion chamber. The shaft may be supported by one or more journal bearings for rotation within the bore about a longitudinal axis. The shaft includes a shaft surface which defines at least a standard region and a feature in a feature region. The feature is configured to generate a plurality of fictitious forces which stabilizes the turbocharger shaft.

The standard region(s) and the feature region(s) which are defined about the surface of the shaft are integral to one another. It is understood that the feature region engages with an oil film disposed along an inner surface of the journal bearing. The shaft may define a single feature or a plurality of features in combination with one or more standard regions. In the aforementioned combination, a lobe may, but not necessarily, be defined between each feature. With respect to the embodiment where a lobe is defined between two feature regions, the minimum radius length in for the recess or recesses, the minimum radius length may but not necessarily be less than the standard radius length by a first radial difference which falls within a range of about 0.1 microns to about 5 microns.

The feature in the feature region may, but not necessarily, be a recess with a minimum radius length which is less than a standard radius length in the standard region. In yet another embodiment, the feature may be a recess having a feature radius length which is greater than the minimum recess radius length. It is also understood that where the feature is a recess, the recess defines a minimum recess radius length in the feature region which is less than a standard radius length in the standard region. The recess or plurality of recesses may, but not necessarily be, one of an oil dam, a slot, and a flat. In such embodiments, each minimum recess radius length in each recess may be less than the standard radius length in the standard region(s) by a second radial difference which falls within the range of about 10 microns to about 0.1 microns.

In yet another embodiment, the turbocharger assembly may include a shaft which defines an oval cross-section. In the embodiment where the shaft has an oval cross-section, the minimum recess radius in the feature region may be less than the standard radius length in the standard region by a second radial difference which falls within the range of about 10 microns to about 0.1 microns.

The present disclosure and its particular features and advantages will become more apparent from the following detailed description considered with reference to the accompanying drawings.

### BRIEF DESCRIPTION OF THE DRAWINGS

These and other features and advantages of the present disclosure will be apparent from the following detailed description, best mode, claims, and accompanying drawings in which:

FIG. 1 is a cross-section of a traditional turbocharger shaft in a journal bearing having lobes.

FIG. 2 is a schematic diagram of an engine assembly of the present disclosure.

FIG. 3 is a cross-sectional view of a turbocharger assembly in accordance with various embodiments of the present disclosure.

FIG. 4A is a cross-sectional view of a first example turbocharger shaft used in the turbocharger assembly of FIG. 3.

FIG. 4B is a cross-sectional view of a second example turbocharger shaft used in the turbocharger assembly of FIG. 3.

FIG. 5 is a cross-sectional view of a third example turbocharger shaft used in the turbocharger assembly of FIG. 3.

FIG. 6 is a cross-sectional view of a fourth example turbocharger shaft used in the turbocharger assembly of FIG. 3.

FIG. 7 is a cross-sectional view of a fifth example turbocharger shaft used in the turbocharger assembly of FIG. 3.

FIG. 8 is a cross-sectional view of a sixth example turbocharger shaft used in the turbocharger assembly of FIG. 3.

Like reference numerals refer to like parts throughout the description of several views of the drawings.

### DETAILED DESCRIPTION

Reference will now be made in detail to presently preferred compositions, embodiments and methods of the present disclosure, which constitute the best modes of practicing the present disclosure presently known to the inventors. The figures are not necessarily to scale. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

Except in the examples, or where otherwise expressly indicated, all numerical quantities in this description indicating amounts of material or conditions of reaction and/or use are to be understood as modified by the word “about” in describing the broadest scope of the present disclosure. Practice within the numerical limits stated is generally preferred. Also, unless expressly stated to the contrary: percent, “parts of,” and ratio values are by weight; the description of a group or class of materials as suitable or preferred for a given purpose in connection with the present disclosure implies that mixtures of any two or more of the members of the group or class are equally suitable or preferred; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this present disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

The term “comprising” is synonymous with “including,” “having,” “containing,” or “characterized by.” These terms are inclusive and open-ended and do not exclude additional, unrecited elements or method steps.

The phrase “consisting of” excludes any element, step, or ingredient not specified in the claim. When this phrase appears in a clause of the body of a claim, rather than immediately following the preamble, it limits only the element set forth in that clause; other elements are not excluded from the claim as a whole.

The phrase “consisting essentially of” limits the scope of a claim to the specified materials or steps, plus those that do not materially affect the basic and novel characteristic(s) of the claimed subject matter.

The terms “comprising”, “consisting of”, and “consisting essentially of” can be alternatively used. Where one of these three terms is used, the presently disclosed and claimed subject matter can include the use of either of the other two terms.

Throughout this application, where publications are referenced, the disclosures of these publications in their entireties are hereby incorporated by reference into this application to more fully describe the state of the art to which this present disclosure pertains.

The following detailed description is merely exemplary in nature and is not intended to limit the present disclosure or the application and uses of the present disclosure. Furthermore, there is no intention to be bound by any theory presented in the preceding background or the following detailed description.

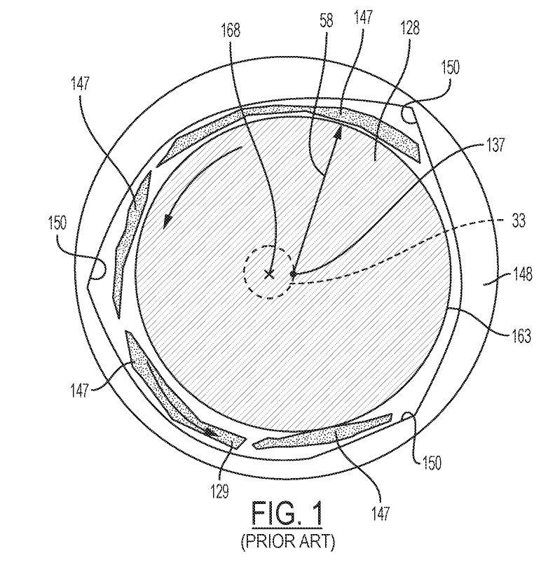

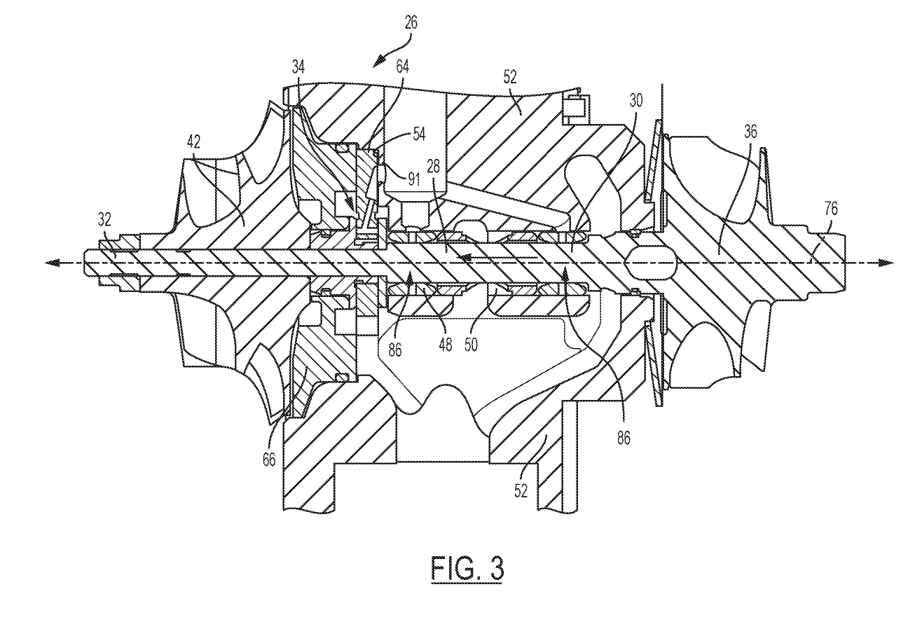

Referring now to FIG. 1, a cross section of a traditional turbocharger shaft 128 in a traditional journal bearing 148 is shown. The shaft 128 may rotate at speeds as high as 300,000 rpm. The shaft's surface speed is shown as w in FIG. 1. Typically, the oil film (schematically represented by 147 in FIG. 3) between the shaft 128 and the journal bearing flows around the journal bearing/shaft interface to lubricate and cool the journal bearing. The average speed of this oil film 147 is approximately 50 percent of the shaft's surface speed (ω/2). Under this arrangement, the turbocharger shaft 128 operates at very high speeds of about 240,000 RPM and given that the turbocharger shaft 128 is lightly loaded, the pressurized oil film 147 can drive the shaft 128 into a circular motion within the journal bearing bore (see orbit 33 for shaft center 137 relative to bearing center 168 in FIG. 3) causing undesirable vibration—known as an oil whirl condition.

Even though the traditional journal bearing 148 may define lobes 150, subsynchronous vibrations due to oil whirl may still occur under this arrangement because that given that the surrounding oil film 147 only travels around the shaft/journal bearing interface at half of the shaft's rotational speed (ω/2) and engages with lobes 150 at such speed (ω/2). This lower frequency within the journal bearing 148 of the prior art generates an unacceptably high amplitude such that unwanted vibration and oil whirl may still occur in a traditional turbocharger assembly.

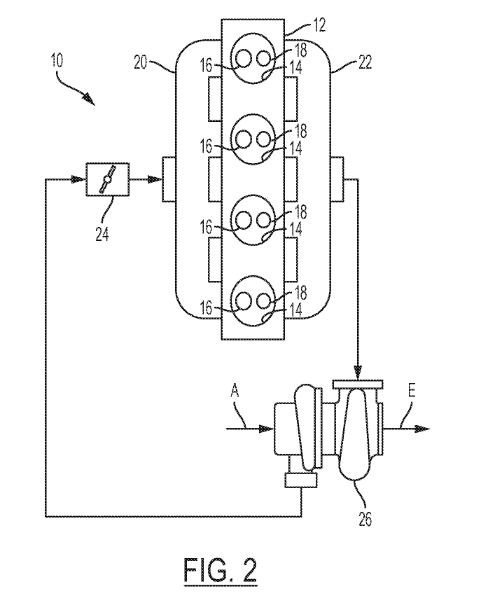

In order to resolve the aforementioned undesirable oil whirl condition, the present disclosure provides an engine assembly 10 which is illustrated in FIG. 2. The engine assembly 10 may include an engine structure 12 defining a plurality of cylinders 14 and intake and exhaust ports 16, 18 in communication with the cylinders 14. An intake manifold 20 is in communication with the intake ports and an exhaust manifold 22 is in communication with the exhaust ports 18. A throttle valve 24 and a turbocharger 26 are provided in an intake passage with air (A) that is connected to the intake manifold 20 and the turbocharger 26 is also in communication with an exhaust passage for exhaust (E) connected to the exhaust manifold 22. The engine assembly 10 is illustrated as an in-line four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations.

As shown in FIG. 3, an example turbocharger 26 of the present disclosure is shown in cross section along shaft axis 76. The turbocharger 26 includes a shaft 28 having a first end 30 and a second end 32. A turbine wheel 36 is mounted on the shaft 28 proximate to the first end 30 and configured to be rotated by combustion exhaust gasses (E in FIG. 2) emitted from the cylinders 14. The turbine wheel 36 is typically formed from a temperature and oxidation resistant material, such as a nickel-chromium-based super-alloy to reliably withstand temperatures of the combustion exhaust gasses which in some engines may approach 2,000 degrees Fahrenheit. The turbine wheel 36 is disposed inside a turbine housing that includes a volute or scroll. The scroll receives the combustion exhaust gases and directs the exhaust gases to the turbine wheel 36.

As further shown in FIG. 3, the turbocharger 26 of the present disclosure also includes a compressor wheel 42 mounted on the shaft 28 proximate to the second end 32. The compressor wheel 42 is configured to pressurize the airflow being received from the ambient for eventual delivery to the cylinders 14. The compressor wheel 42 is disposed inside a compressor cover that includes a volute or scroll. The scroll receives the airflow and directs the airflow to the compressor wheel 42. Accordingly, rotation is imparted to the shaft 28 by the combustion exhaust gases energizing the turbine wheel 36, and is in turn communicated to the compressor wheel 42.

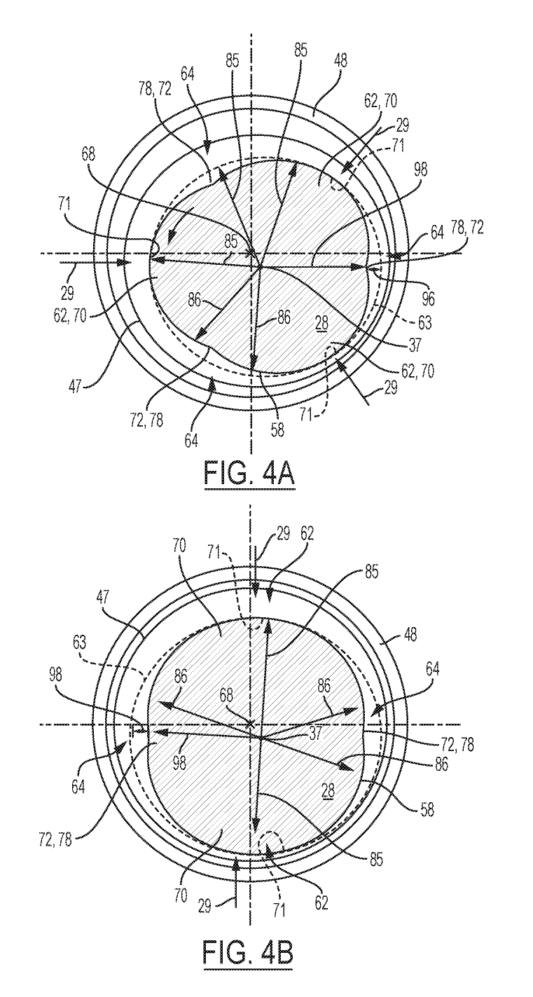

With continued reference to FIG. 3, the shaft 28 is supported for rotation via a journal bearing 48 with a film of oil (shown schematically as element 47 in FIGS. 4A-8) in between. The journal bearing 48 is mounted in a bore 50 of the turbocharger housing 52 as shown in FIG. 3. The journal bearing is lubricated and cooled by a supply of pressurized engine oil 47 (FIGS. 4A-8). The turbocharger housing 52 may also include a thrust wall 54. As shown, the turbocharger 26 may also include a thrust journal bearing 64 that is held in place by a compressor backplate 66 against the journal bearing wall 54.

Accordingly, with reference to FIGS. 3-8, the present disclosure provides a turbocharger assembly 26 which significantly reduces and/or eliminates the subsynchronous excitation signal, vibration and oil whirl which was previously described. As shown in FIG. 3, the turbocharger assembly 26 of the present disclosure includes a turbocharger housing 52 which defines a bore 56, a journal bearing 48, a rotary assembly 34. A pair of journal bearing 48 may be disposed within the bore 56. The rotary assembly 34 includes a shaft 28, a turbine wheel 36 and a compressor wheel 42. The turbine wheel 36 is configured to be driven by the post-combustion gasses while the compressor wheel 42 is configured to pressurize the airflow for delivery to a combustion chamber. Referring now to FIGS. 3-8, the shaft 28 may be supported by an oil film 47 within one or more journal bearings 48 for rotation within the bore 56 (FIG. 2) about a longitudinal axis 76 (FIG. 2). With reference to FIGS. 4-9, the shaft 28 includes a shaft surface 58 which defines a standard region 62 and a feature 78 in a feature region 64. The combination of the features 78 and the standard regions 62 which are defined on the shaft (in a high speed rotating frame) are configured to generate fictitious forces 29 on the shaft 28 due to the oil 47 disposed between the continuously changing clearance between the shaft surface and the bearing—given that the shaft (with a varying surface) rotates at very high speeds (ω) while the oil film 47 travels at half of the shaft speed (ω/2). Given that the turbocharger shaft rotates at very high speeds (ω) of about 240,000 rpm, the fictitious forces 29 (FIGS. 4A-8) about the shaft 28 are sufficiently high to maintain the shaft 28 in its eccentric position within the journal bearing—such that the shaft center 37 no longer rotates in an orbit at half of the shaft speed (ω/2) (see example element 33 in FIG. 1). Rather shaft center 37 stays substantially fixed relative to the bearing center 68 and oil whirl is eliminated (FIGS. 4A-8). However, in the event that the mass center is not at the same location of the shaft center and if the resulting shaft load is rotating at the same speed as the shaft speed, then the shaft center will also rotate at the shaft speed thus being synchronous.

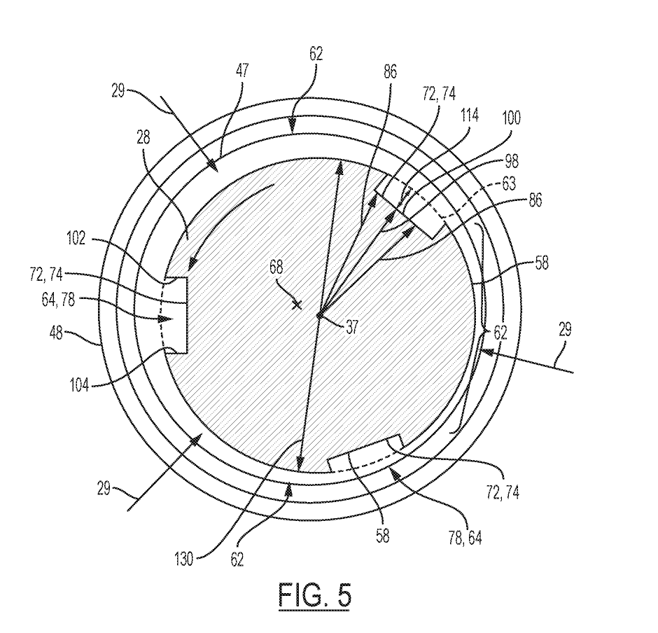

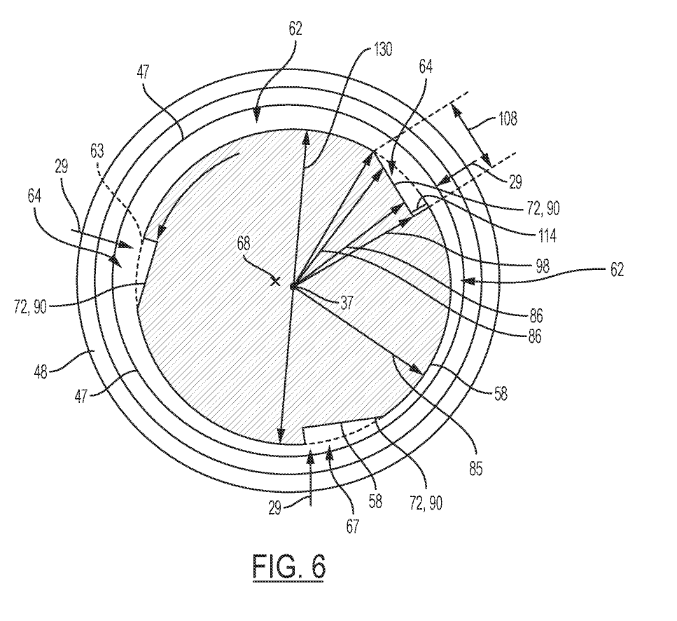

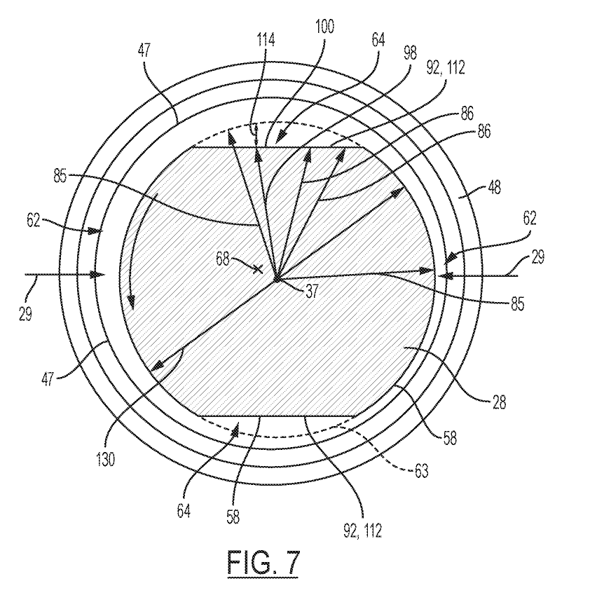

As shown in FIGS. 4A-8, in the present disclosure, the standard regions 62 of the shaft 28 of the present disclosure define a surface of the shaft which is located at the standard shaft radius 85. (The standard shaft radius length 85 is a fixed value and is equivalent to the radius length of a standard shaft, such as element 128 in FIG. 1, which does not include any features as shown in FIG. 1). However, the feature region(s) 64 of the shaft 28 of the present disclosure may, but not necessarily, have a feature radii lengths 86 which may vary across the feature region 64 as shown in the example feature radii lengths 86 in FIGS. 4-9. The standard region(s) 62 is/are integral to the feature region(s) 64 as shown in FIGS. 4A-8. The shaft 28 of the present disclosure may include any mixed combination of standard and feature regions 62, 64 over the surface 58 of the shaft 28 which includes but is not limited to a plurality of standard and feature regions 62, 64. However, it is understood that it is alternatively possible for the shaft 28 to simply define as little as one standard region 62 and one feature region 64 (not shown). As shown in the example of FIG. 4, standard regions 62 are defined on the shaft surface 58 in combination with a plurality of features 78 which are each in the form of a recess 72. As a result of the alternating features 78 and standard regions 62, three lobes 70 are formed as shown in FIG. 4. Similarly, in FIGS. 5-7, standard regions 62 may be also defined on the shaft surface 58 in combination with a plurality of features 78 wherein each feature 78 is a recess 72 of other varying types. The recess 72 may also be provided in the form of a slot 74 (FIG. 5), an oil dam 90 (FIG. 6), or a flat 92 (FIG. 7).

Regardless of whether the combination of standard regions 62, features 78, and feature regions form lobes, slots, oil dams, or the like, the varying shaft surface 58 (over the shaft circumference having recesses 72 and standard regions 62) rapidly engages with surrounding oil film 47 around the shaft 28 which travels at half of the shaft's rotational speed (ω/2)—such that fictitious forces 29 are generated around the shaft 28. Given that the turbocharger shaft 28 rotates at a very high speed of approximately 240,000 RPM, the fictitious forces 29 on the rotating shaft 28 reach significant levels as the shaft speed increases such that the rotating shaft 28 is heavily loaded under the fictitious forces 29. Accordingly, the relatively high fictitious forces 29 which are balanced around the shaft 28 prevent the shaft 28 from whirling in the shaft's orbit (element 33 in FIG. 1) within the journal bearing 48 (relative to the center 68 of the journal bearing 48) and therefore, the rotating shaft 28 is stabilized when the shaft 28 is in motion.

Referring now to the example shown in FIG. 4A, the shaft 28 may but not necessarily, include three features 78 combined with standard regions 62 wherein each feature 78 is in the form of a gradual recess 72 until the shaft surface is defined at the minimum radius length 98. Again, as shown in FIG. 4A, the standard region 62 is any portion of the shaft surface 58 wherein the radius of the shaft 28 is equivalent to the standard radius length 85. For purposes of comparison, a standard shaft 63 having a standard radius length 85 (which is fixed) is shown in dashed lines as element 63 in all embodiments (FIGS. 4-9). As shown in FIG. 4A, each feature 78 (recess 72) alternates around the circumference of the shaft 28 such that lobes 70 are formed between each recess 72. While three lobes 70 are shown with three feature regions (recesses) 72 in FIG. 4A, it is understood that the shaft 28 may have as little as two feature region 64 (in the form of recesses like element 72) (not shown) and one lobe 70 region (not shown) such that only one lobe 70 is defined by the shaft 28.

Regardless, when the feature 78 is implemented on the shaft 28 as a recess 72, the feature 78 (recess 72) may have a minimum recess radius length 98 which is less than a standard radius length 85 in the standard region 62 as shown in FIG. 4A. The feature region 64(s) of the various embodiments of the present disclosure may be defined across the entire longitudinal surface 58 of the shaft 28 (along axis 76) to simplify the manufacturing process. However, the feature region(s) 64 and standard regions 62 of the various embodiments may alternatively be defined only in the areas 86 (FIG. 3) where the shaft 28 is supported by an oil film 47 within the journal bearing 48 as shown in FIG. 3.

Referring again to FIG. 4A, the example feature 78 is a recess 72 having a varying feature radius length 86 (across the feature region 62 in the form of recess 72 in FIG. 4A) and a minimum recess radius length 98 which are all less than the standard radius length 85 in the standard region 62. In the example of FIG. 4A, the standard region 62 coincides with the apex region 71 for each lobe 70. As shown, the radius of the shaft 28 at the apex 71 of each lobe 70 is also equal to the standard radius length 85. In contrast, the minimum recess radius length 98 is less than any of the feature radii lengths 86. The minimum recess radius length 98 may be less than the standard radius length 85 by a first radial difference 96 which falls within a range of about 0.1 microns to about 5 microns when the shaft diameter 130 is about 6 mm.

Similarly, in another example embodiment in FIG. 4B, the shaft 28 may but not necessarily, include two features 78 combined with two standard regions 62 wherein each feature 78 is in the form of a gradual recess 72 until the shaft surface is defined at the minimum radius length 98. Again, as shown in FIG. 4B, the standard region 62 is any portion of the shaft surface 58 wherein the radius of the shaft 28 is equivalent to the standard radius length 85 as previously defined. For purposes of comparison, a standard shaft 63 having a standard radius length 85 (which is fixed) is shown in dashed lines as element 63 in all embodiments (FIGS. 4A-9). As shown in FIG. 4B, each feature 78 (recess 72) alternates around the circumference of the shaft 28 such that a lobe 70 is formed between each recess 72. Two lobes 70 are shown with two feature regions (recesses) 72 in FIG. 4B.

Similarly, in FIG. 4B, when the feature 78 is implemented on the shaft 28 as a recess 72, the feature 78 (recess 72) may have a minimum recess radius length 98 which is less than a standard radius length 85 in the standard region 62 as shown in FIG. 4B and is also less that the feature radius length 86 which may vary across the feature region 64. As shown in FIG. 4B, the example feature 78 is a recess 72 having a varying feature radius length 86 (across the feature region 62 in the form of recess 72 in FIG. 4B) and a minimum recess radius length 98 which are all less than the standard radius length 85 in the standard region 62. In the example of FIG. 4B, the standard region 62 coincides with the apex region 71 for each of the two lobes 70. As shown, the radius of the shaft 28 at the apex 71 of each lobe 70 is also equal to the standard radius length 85. In contrast, the minimum recess radius length 98 is less than any of the feature radii lengths 86. The minimum recess radius length 98 may be less than the standard radius length 85 by a first radial difference 96 which falls within a range of about 0.1 microns to about 5 microns when the shaft diameter 130 is about 6 mm.

Referring now to the non-limiting examples shown in FIGS. 5-7, the shaft 28 may but not necessarily, include three features 78 combined with standard regions 62 wherein each feature 78 is in the form of a recess 72. The recess 72 may be a slot 74 (FIG. 5), an oil dam 90 (FIG. 6), or a flat 92 (FIG. 7). The recess 72 may have a feature radius length 86 and a minimum recess radius length 98 which are both less than a standard radius length 85 in the standard region 62 as shown in FIGS. 5-7. When the recess 72 is provided in the form of a slot 74, the feature radius length 86 may vary across the width of the slot 74 as shown in FIG. 5. In this embodiment, the minimum recess radius length 98 is at the middle region 100 of the slot 74. The recess 72 in the form of the slot 74 may also further define a first sidewall 102 and a second sidewall 104 for the slot 74. However, when the recess 72 is provided in the form of an oil dam 90, the feature radius length 86 gradually decreases across the width 108 of the oil dam 90 as shown in FIG. 6. Moreover, when the recess 72 is provided in the form of a flat 92 as shown in FIG. 7, the feature radius length 86 varies across the flat 92 such that the recess is a flat surface 112 (lacking any sidewalls) wherein the minimum recess radius length 98 is shown. The minimum recess radius length is also disposed in the middle region of the flat 92. Referring now to FIGS. 5-7, the minimum recess radius length 98 of these embodiments may, but not necessarily be, less than the standard radius length 85 by a second radial difference 114 which falls within the range of about 10 microns to about 0.1 microns when the shaft 28 diameter 130 is 6 mm.

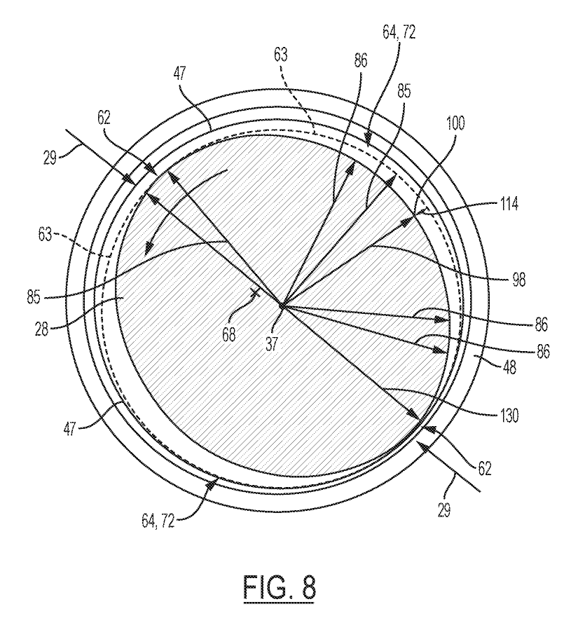

With reference to FIG. 8, the shaft 28 may have a combination of feature and standard regions such that cross-section of the shaft is in the form of an oval. Again, the feature of the feature region is a recess 72 in that the varying feature radiii lengths 86 and the minimum recess radius length 98 which are all less than a standard radius length 85 in the standard region 62. When the recess 72 is provided to create the oval cross section as shown in FIG. 8, the feature radius length 86 may vary across the feature region. In this embodiment, the minimum recess radius length 98 is at the middle region 100 of the feature 78. In FIG. 8, the minimum recess radius length 98 may be less than the standard radius length 85 by a second radial difference 114 which falls within the range of about 10 microns to about 0.1 microns when the shaft diameter 130 is 6 mm.

While example embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A turbocharger assembly for a vehicle comprising:
a turbocharger housing;
a bore defined by the turbocharger housing,
a journal bearing disposed within the bore; and
a rotating assembly having a shaft with a turbine wheel on a first end of the shaft and a compressor wheel on a second end of the shaft, the shaft being supported by an oil film in a journal bearing for rotation within the bore about a longitudinal axis;
wherein the shaft defines a standard region and a feature in a feature region, the feature being one of a recess or a lobe configured to generate a plurality of fictitious forces which stabilize the shaft within the journal bearing.

2. The turbocharger assembly as defined in claim 1 wherein the standard region and the feature region are integral to one another.

3. The turbocharger assembly as defined in claim 2 wherein the feature region engages with an oil film disposed along an inner surface of the journal bearing.

4. The turbocharger assembly as defined in claim 3 wherein the shaft defines a plurality of features.

5. The turbocharger assembly as defined in claim 3 wherein the feature is a recess with a minimum radius length which is less than a standard radius length in the standard region.

6. The turbocharger assembly as defined in claim 4 wherein a lobe is defined between each feature.

7. The turbocharger assembly as defined in claim 5 wherein the feature is a recess having a feature radius length which is greater than the minimum recess radius length.

8. The turbocharger assembly as defined in claim 4 wherein the feature is a recess, the recess having a minimum recess radius length which is less than a standard radius length in the standard region.

9. The turbocharger assembly as defined in claim 5 wherein the recessed region is one of an oil dam, a slot, and a flat.

10. The turbocharger assembly as defined in claim 8 wherein the recessed region is one of an oil dam, a slot, and a flat.

11. The turbocharger assembly as defined in claim 8 wherein the shaft defines an oval cross-section.

12. The turbocharger assembly as defined in claim 5 wherein the minimum radius length is less than the standard radius length by a first radial difference which falls within a range of about 0.1 microns to about 5 microns.

13. The turbocharger assembly as defined in claim 6 wherein the minimum radius length is less than the standard radius length by a first radial difference which falls within a range of about 0.1 microns to about 5 microns.

14. The turbocharger assembly as defined in claim 9 wherein the minimum recess radius length is less than the standard radius length by a second radial difference which falls within the range of about 10 microns to about 0.1 microns.

15. The turbo charger assembly as defined in claim 10 wherein the minimum recess radius is less than the standard radius length by a second radial difference which falls within the range of about 10 microns to about 0.1 microns.

16. The turbo charger assembly as defined in claim 11 wherein the minimum recess radius is less than the standard radius length by a second radial difference which falls within the range of about 10 microns to about 0.1 microns.
